(19) United States
(12) Patent Application Publication
(10) Pub. No.: US 2011/0020127 A1
(43) Pub. Date: Jan. 27, 2011

(54) Component Comprising Overlapping Weld Seams and Method for the Production Thereof

(76) Inventors: Bernd Burbaum, Ubach-Palenberg (DE); Selim Mokadem, Dusseldorf (DE); Norbert Pirch, Aachen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/934,105

(22) PCT Filed: Mar. 24, 2009
(86) PCT No.: PCT/EP2009/053444

§ 371 Date: Sep. 23, 2010

(30) Foreign Application Priority Data
Mar. 28, 2008 (DE) 10 2008 016 170.5

(51) Int. Cl. F01D 5/14; B23K 26/24

(52) U.S. Cl. 416/223 A; 219/121.64

(57) ABSTRACT

A turbine blade or vane with a platform and two overlapping weld seams, each weld seam having a width, is provided. An overlapping region of the two weld seams is 40% to 60% of the width of one weld seam. The weld seams run parallel or perpendicularly to the platform of the turbine blade or vane. Further, a method for welding a turbine blade or vane is provided.

### CROSS REFERENCE TO RELATED APPLICATIONS

This application is the US National Stage of International Application No. PCT/EP2009/053444 filed Mar. 24, 2009, and claims the benefit thereof. The International Application claims the benefits of German Application No. 10 2008 016 170.5 DE filed Mar. 28, 2008. All of the applications are incorporated by reference herein in their entirety.

### FIELD OF INVENTION

The invention relates to a component comprising partly overlapping weld seams and to a process for producing such a component.

### BACKGROUND OF INVENTION

In welding, in particular in laser welding, it is often necessary to weld regions having a large surface area. One welding track of a laser is not sufficiently wide to weld the surface in one pass. A plurality of contiguous tracks is therefore produced.

According to the existing prior art, production times are kept low by positioning the welding tracks one directly inside another. However, the welding results are not always satisfactory.

### SUMMARY OF INVENTION

It is an object of the claimed invention to provide a component comprising weld seams and a process, in which the overall welding result in a region having a large surface area is satisfactory.

The object is achieved by a component and by a process for producing such weld seams as claimed in the independent claims.

The dependent claims list further advantageous features which can be combined with one another, as desired, in order to obtain further advantages.

### BRIEF DESCRIPTION OF THE DRAWINGS

FIG. 1 shows overlapping weld seams,

FIG. 2 shows an arrangement of weld seams,

FIG. 3 shows a gas turbine,

FIG. 4 shows a perspective view of a turbine blade or vane,

FIG. 5 shows a perspective view of a combustion chamber, and

FIG. 6 shows a list of superalloys.

The figures and the description represent only exemplary embodiments of the claimed invention.

### DETAILED DESCRIPTION OF INVENTION

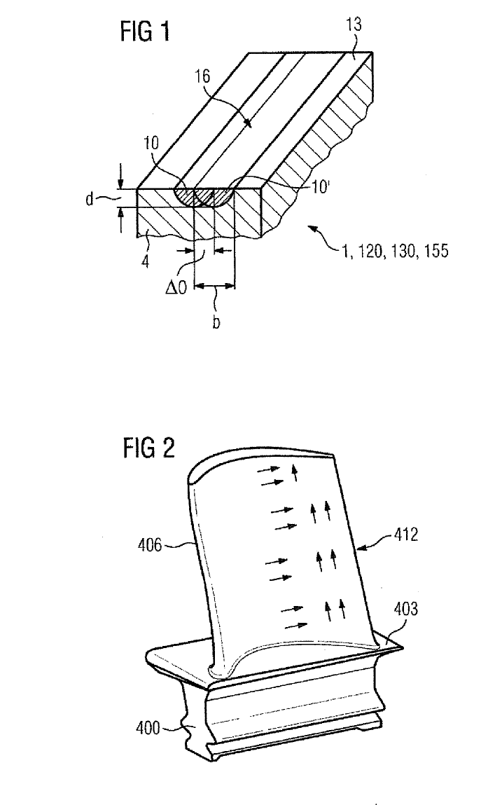

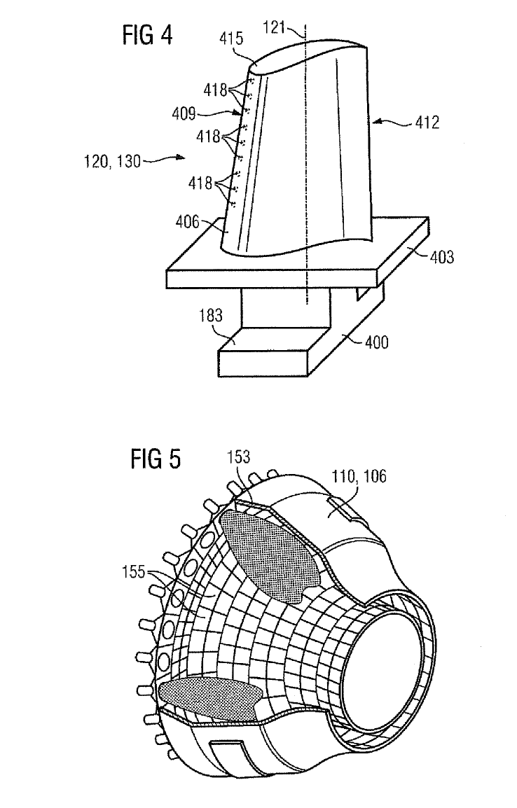

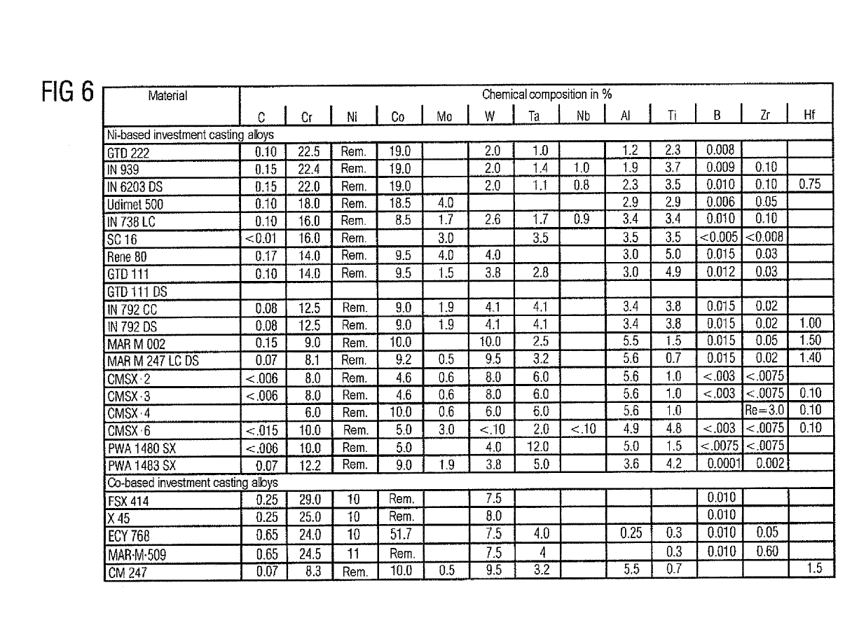

FIG. 1 shows a component 1, 120, 130, 155 (FIGS. 4, 5), in particular a component 120, 130, 155 of a gas turbine 100 (FIG. 3).

The substrate 4 of the component 1, 120, 130, 155 preferably has a superalloy according to FIG. 6.

Material is applied to a large area of the surface 13 of the substrate 4 and melted (supply of welding material) in order to achieve wall thickening, for example, or material of the substrate 4 is remelted (no supply of welding material) in order to close cracks or in order to melt a weld seam which already exists a second time. In any case, welding is intended to take place over a large surface area, and therefore a plurality of weld seams 10, 10′ have to be used.

After the first welding operation, the substrate 4 has a weld seam 10. The weld seam 10 has a defined width b. This is followed by the production of a second weld seam 10′, which overlaps the first weld seam 10. The weld seams 10, 10′ have a comparable width b, in particular in line with the manufacturing tolerance. The width b of the weld seams 10, 10′ is preferably 4 mm. The same welding parameters are preferably used for the weld seams 10, 10′.

FIG. 1 shows the overlap ΔO of two weld seams 10, 10′ in cross section. The adjacent weld seams 10, 10′ overlap by an overlapping region ΔO, where ΔO is 40% to 60% of the width b of a weld seam 10, 10′. ΔO is preferably 45% to 55% of the width b, in particular 50%.

Since the weld seams 10, 10′ overlap, a virtually uniform thickness d of a welded surface 16 is obtained, this surface 16 being produced by the weld seams 10, 10′. In the case of an excessively small spacing or overlap of the weld seams 10, 10′, a uniform thickness of a relatively large welded surface 16 is not obtained. A homogeneous welded surface 16, which stems from the double welding in the overlapping region ΔO, is therefore obtained without a relatively large increase in the production time. In this case, a laser having a power of 350 W to 500 W has preferably been used for welding. A preheating temperature of about 500° C. is preferably used. The travel speed is preferably 50 mm/min.

The depth to which the weld seams 10, 10′ penetrate into the substrate 4 is preferably 1100 μm.

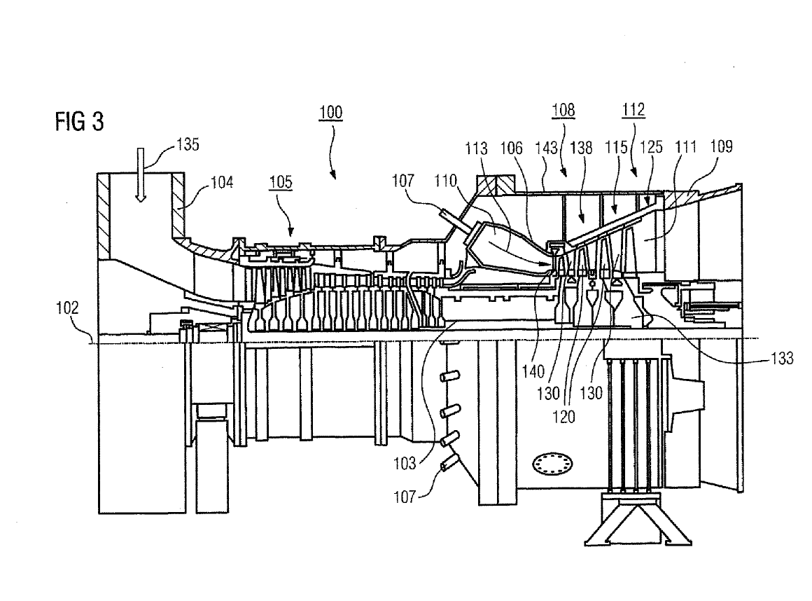

In the case of a turbine blade or vane 120, 130, the weld seams 10, 10′ run parallel or perpendicularly to the blade or vane platform 403 (FIG. 2), even independently of an overlap. “Perpendicularly” means that the longitudinal direction (as vector) of the weld seam 10, 10′ is perpendicular on the surface of the blade or vane platform 403. “Parallel” means that the longitudinal direction (as vector) of the weld seam 10 runs parallel to the surface of the blade or vane platform 403.

Independently of an overlap of the weld seams, but also if weld seams overlap, weld seams are positioned as far as possible parallel to the orientation of dendrites in a turbine blade or vane 120, 130 which comprises columnar grains or a single crystal. A first preferred direction of the dendrites is parallel to the longitudinal axis 121 (FIG. 4). The other two directions are perpendicular to said first preferred direction and are also perpendicular to one another. In this case, the selection of the direction of the weld seams also depends on the cracking profile or extent of the surface to be welded.

FIG. 3 shows, by way of example, a partial longitudinal section through a gas turbine 100. In the interior, the gas turbine 100 has a rotor 103 with a shaft which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses. To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110. Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloys.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 4 shows a perspective view of a rotor blade 120 or guide vane 130 of a turbomachine, which extends along a longitudinal axis 121. The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415. As a guide vane 130, the vane 130 may have a further platform (not shown) at its vane tip 415. A blade or vane root 183, which is used to secure the rotor blades 120, 130 to a shaft or a disk (not shown), is formed in the securing region 400. The blade or vane root 183 is designed, for example, in hammerhead faun. Other configurations, such as a fir-tree or dovetail root, are possible. The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130. Superalloys of this type are known, for example, from EP 1 204 776 B1, EP 1 306 454, EP 1 319 729 A1, WO 99/67435 or WO 00/44949; these documents faun part of the disclosure with regard to the chemical composition of the alloy.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures). Processes of this type are known from U.S. Pat. No. 6,024,792 and EP 0 892 090 A1; these documents form part of the disclosure with regard to the solidification process.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of this disclosure with regard to the chemical composition of the alloy.

The density is preferably 95% of the theoretical density.

A protective aluminum oxide layer (TGO=thermally grown oxide layer) is formed on the MCrAlX layer (as an intermediate layer or as the outermost layer). The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX. The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

The blade or vane 120, 130 may be hollow or solid in form. If the blade or vane 120, 130 is to be cooled, it is hollow and may also have film-cooling holes 418 (indicated by dashed lines).

FIG. 5 shows a combustion chamber 110 of the gas turbine 100. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154. On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1, which are intended to faun part of this disclosure with regard to the chemical composition of the alloy.

It is also possible for a, for example, ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide. Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thennal shocks.

Refurbishment means that after they have been used, protective layers may have to be removed from turbine blades or vanes 120, 130 or heat shield elements 155 (e.g. by sand-blasting). Then, the corrosion and/or oxidation layers and products are removed. If appropriate, cracks in the turbine blade or vane 120, 130 or in the heat shield element 155 are also repaired. This is followed by recoating of the turbine blades or vanes 120, 130 or heat shield elements 155, after which the turbine blades or vanes 120, 130 or the heat shield elements 155 can be reused.

1.-16. (canceled)

17. A turbine blade or vane, comprising:
a platform;
two overlapping weld seams, each weld seam having a width;
an overlapping region of the two weld seams, wherein the overlapping region is 40% to 60% of the width of one weld seam,
wherein the weld seams run parallel or perpendicularly to the platform of the turbine blade or vane.

18. The turbine blade or vane as claimed in claim 17, wherein the overlapping region is 50% of the width of one weld seam.

19. The turbine blade or vane as claimed in claim 17, further comprising:
a plurality of columnar grains.

20. The turbine blade or vane as claimed in claim 17, further comprising:
a single crystal.

21. The turbine blade or vane as claimed in claim 17, wherein the weld seams, as far as possible, run parallel to an orientation of dendrites in the turbine blade or vane.

22. A method for welding a turbine blade or vane, comprising:
producing a first weld seam having a first width; and
producing a second weld seam having a second width;
wherein the second weld seam overlaps the first weld seam, and
wherein an overlapping region of the weld seams is at least 40% and at most 60% of the first or second width of the weld seams.

23. The method as claimed in claim 22, wherein the overlapping region is 50% of the first or second width of the weld seams.

24. The method as claimed in claim 22, further comprising:
using a turbine blade or vane, the first and second weld seams being producing on the turbine blade or vane; and
using a welding appliance, wherein a power of the welding appliance is between 350 W and 500 W.

25. The method as claimed in claim 24, wherein the welding appliance is a laser.

26. The method as claimed in claim 22, wherein the weld seams are positioned parallel to a platform of a turbine blade or vane.

27. The method as claimed in claim 22, wherein the weld seams are positioned perpendicular to a platform of a turbine blade or vane.

28. The method as claimed in claim 24, wherein the turbine blade or vane comprises columnar grains.

29. The method as claimed in claim 24, wherein the turbine blade or vane comprises a single crystal.

30. The method as claimed in claim 24, wherein weld seams are positioned parallel to an orientation of dendrites in the turbine blade or vane.

31. The method as claimed in claim 22, further comprising:
adding welding material during the producing of the weld seams.

32. The method as claimed in claim 22, wherein no welding material is added during the producing of the weld seams.

33. A turbine blade or vane, comprising:
a platform; and
columnar grains, wherein weld seams run parallel or perpendicular to the platform.

34. The turbine blade or vane as claimed in claim 33, wherein the turbine blade or vane comprises a single crystal instead of columnar grains.

35. The turbine blade or vane as claimed in claim 33, wherein the weld seams, as far as possible, run parallel to an orientation of dendrites in the turbine blade or vane.
